(19) United States
(12) Patent Application Publication
(10) Pub. No.: US 2011/0166932 A1
(43) Pub. Date: Jul. 7, 2011

(54) SYSTEM AND METHOD OF PROVIDING CONTENT BASED ON USER INTERACTION

(75) Inventors: ALLEN W. SMITH, San Diego, CA (US); Daniel M. Rivas, San Diego, CA (US); Per O. Nielsen, San Diego, CA (US); Susan J. McGarry, San Diego, CA (US)

(73) Assignee: QUALCOMM Incorporated, San Diego, CA (US)

(21) Appl. No.: 12/729,880

(22) Filed: Mar. 23, 2010

Related U.S. Application Data
(60) Provisional application No. 61/293,059, filed on Jan. 7, 2010.

(51) Int. Cl. G06Q 30/00; G06F 3/048

(52) U.S. Cl. 705/14.53; 715/835; 715/844

(57) ABSTRACT

Methods and systems provide for displaying advertisement items on mobile devices in response to user selections. Advertisement items may be transmitted to mobile devices ahead of an insertion point and stored in memory. While displaying a content item, mobile devices may display a list of alternatives related advertisement content and prompt the user to select one. Mobile devices may determine an advertisement content item to display at the insertion point based on a received user input or lack of an input. In a further embodiment, mobile devices report displayed advertisement items to a service, such as the distributor, content provider, or a third party. In a further embodiment, the selection of alternative advertisement items to present to the user is made based upon weighting values associated with each advertisement item. Such weighting values may be adjusted when advertisement items are displayed or listed in a user interface display.

### RELATED APPLICATIONS

This application claims the benefit of priority to U.S. Provisional Patent Application No. 61/293,059 entitled “System and Method of Providing Content Based on User Interaction” filed Jan. 7, 2010, the entire contents of which are hereby incorporated by reference.

### BACKGROUND

Wireless communication technologies have seen explosive growth over the past few years. This growth has been fueled by wireless services providing freedom of movement to the mobile public, and cutting the tether to hardwired communication systems. As a result of service enhancements, the popularity of wireless services is expected to continue to grow rapidly. A recent addition to wireless communication services has been the ability to broadcast television and other content to mobile devices. Mobile multimedia broadcast services allow users to view TV programming, as well as receive mobile editions of news, entertainment, sports, business, and other programming, using their cell phone or other wireless mobile device configured to receive the mobile broadcast transmissions.

### SUMMARY

The various embodiments enable mobile multimedia broadcasters to provide advertising content within broadcast programs that allow mobile device viewers to select advertisements for viewing based on a type, subject matter, advertiser or other category. While displaying content items, such as videos, television programs, or other multimedia content, the mobile device may reach a point indicated for inserting an advertisement item. Multiple advertisement content items may be broadcast to mobile devices through a broadcast system either ahead of time or during the broadcast of content items. Advertising content broadcast ahead of time may be cached in memory until the insertion time. Mobile devices may display a menu of advertisement type alternatives and prompt the user to select one. Mobile devices may determine which of a plurality of advertisement content items to display based on the user's input or lack of input. In a further embodiment, the mobile devices may record the advertising content selected and displayed to users, and report this information to the broadcaster, a content provider, or other service. In a further embodiment, weighting values may be assigned to advertising content items and used by mobile devices to determine which content items will be presented to the user for selection in the displayed menu of alternatives.

The various embodiments may be implemented as methods performed within a mobile device, as a mobile device configured to perform the embodiment methods, and as a tangible storage medium including processor-executable instructions which cause a processor of a mobile device to perform the embodiment methods.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating an example communication system providing broadcast programming to mobile devices.

FIG. 2 is a component block diagram of a mobile device suitable for use in an embodiment.

FIGS. 3A-3C are illustrations of images presented on a display of a mobile device during implementation of an embodiment.

FIG. 4 is a process flow diagram of an embodiment method for displaying advertising content based on a user interaction.

FIG. 5 is a process flow diagram of an embodiment method for displaying advertising content based on user interactions and reporting such interactions to an interested party.

FIG. 6 is a process flow diagram of an embodiment method for displaying advertising content based on user interactions and weighting values associated with the content.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any embodiment described herein as “exemplary” is not necessarily to be construed as preferred or advantageous over other embodiments.

As used herein, the terms “mobile device” and “receiver device” refer to any one or all of: cellular telephones, personal data assistants (PDAs), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, interactive gaming devices, portable television devices (e.g., FLO TV® devices), and similar personal electronic devices which may include a programmable processor, memory, and a wireless communication receiver or transceiver circuit.

As used herein, the term “multimedia content” generally refers to an electronically delivered combination of media including text, audio, still images, and video. Multimedia content can also refer to singular media capable of being electronically presented to a user, such as is the case with music, video and animation. Multimedia content may, for example, comprise (but is not limited to) any of a variety of streaming file types including QUICKTIME, MPEG 2, MPEG 4, AVI, etc. The multimedia content may be streamed using a variety of methodologies, including broadcast, unicast, and multicast. As used herein, the term “content item” refers to a file or other data item that is broadcast and may be stored within memory of mobile devices, including multimedia content. “Advertisement item” and “advertisement content item” refer to a type of “content item” used to convey an advertisement for display on mobile devices.

The various embodiments provide methods and systems for displaying advertisement items on mobile devices in response to user selections. Several advertisement items may be made available to the mobile device through a broadcast system either ahead of time or during the broadcast of the other content items. While displaying a content item, such as videos or other multimedia content, the mobile device may reach a point indicated for inserting an advertisement item. This insertion point or time may be identified by an indicator or indicia within the broadcast content stream. Before the insertion point or time the mobile device displays a list of alternatives related advertisement content (e.g., alternative types of advertisements or alternative advertisements) and prompts the user to select one. The mobile device determines an advertisement content item to display based on a received user input or lack of input. In a further embodiment, the mobile device reports displayed advertisement items to the distributor, content provider, a third party service provider, or other service. In a further embodiment, the selection of alternative advertisement items to present to the user is made based upon weighting values associated with each advertisement item.

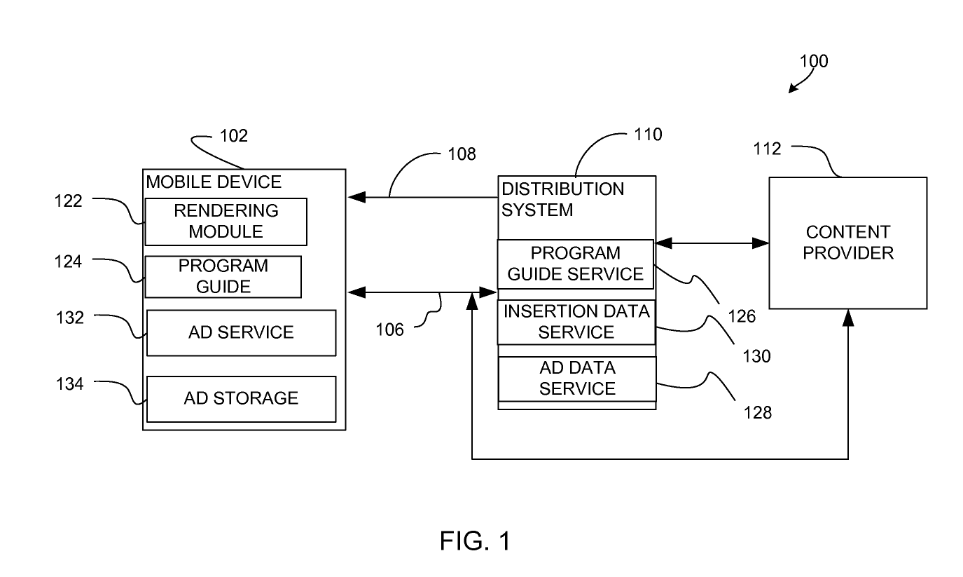

FIG. 1 is a block diagram illustrating an example system 100 for broadcasting multimedia content to mobile devices 102 from one or more content providers 112 via a distribution system 110. In the various embodiments advertisement content items are broadcast to the mobile device 102 where they may be selectively displayed at an appropriate time within a broadcast program based on interactions with a user of the mobile device 102. For example, the system 100 may broadcast a plurality of different advertising content in advance for storage in memory (e.g., ad storage 134) of the mobile device 102 and, at an appropriate time within a broadcast stream of multimedia content, instruct the mobile device 102 to insert one of the plurality of stored advertisement items at an insertion time in the broadcast stream of multimedia content. The mobile device 102 may generate a display menu of alternative advertisement items or types of advertising content available for presentation and prompt the user to make a selection. Graphical indicators for each of the advertisement items may be included in the menu display along with an interface (e.g., an icon or indication of appropriate menu selection keys) for the user to select one of the advertisement items or type of advertisement content. The mobile device 102 may receive the user input, if any, and recall for display a selected advertisement item or an advertisement item corresponding to a selected type of advertising content. If the user fails to make any selection, a default advertisement item may be recalled and displayed on the mobile device.

Referring once again to FIG. 1, the distribution system 110 may receive a stream of data comprising multimedia content from a content provider 112 and transmit the multimedia content to one or more mobile devices 102 via a first communication link 108. FIG. 1 illustrates an aspect in which the content provider 112 transmits content to the mobile device 102 through the distribution system 110. However, the content provider 112 may communicate the content directly to the mobile device 102 (not shown in FIG. 1), bypassing the distribution system 110, for example utilizing the first communications link 108. In other aspects multiple content providers 112 may provide multimedia content via multiple distribution systems 110 to the mobile devices 102.

In the example illustrated in FIG. 1, the first communication link 108 is a forward link only (FLO) wireless broadcast, as may be provided by mobile broadcast system. Examples of mobile multimedia broadcast systems include, Open Mobile Alliance Mobile Broadcast Services Enabler Suite (OMA BCAST), MediaFLO®, Digital Video Broadcast IP Datacasting (DVB-IPDC), DVB-H, and China Multimedia Mobile Broadcasting (CMMB). However, the aspects described herein are not limited to a forward link only wireless broadcast unless specifically recited in the claims, and may utilize a variety of transmission technologies and techniques, including Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, and an orthogonal frequency division multiple access (OFDM) communication system.

The distribution system 110 is also configured to communicate over a second communication link 106. In the example illustrated in FIG. 1, the second communication link 106 is a bi-directional wireless telecommunication link. In this aspect, the second communication link 106 is configured to communicate voice traffic and/or data traffic among and between various devices, including multiple mobile devices 102. The communication link 106 may also communicate transmission schedules and other data between the distribution system 110 and the mobile devices 102. The second communication link 106, as used by the aspects described herein is not limited to a bi-directional wireless telecommunication link, or even any particular telecommunication technology. In this regards, the second communication link 106 may comprise one or more wired and/or wireless links, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, and an orthogonal frequency division multiple access (OFDM) system.

The distribution system 110 may also include a program guide service 126. The program guide service 126 receives programming schedule and content related data from the content provider 112 and/or other sources and communicates data defining an electronic programming guide (EPG) 124 to the mobile device 102. The EPG 124 may include data related to the broadcast schedule of multiple broadcasts of particular content items available to be received over the communication link 108. The EPG data may include titles of content items, start and end times of particular broadcasts, channels or flow IDs on which the content may be received, category classifications of programs (e.g., sports, movies, comedy, etc.), quality ratings, adult content ratings, etc. The EPG 124 may be communicated to the mobile device 102 over either the first communication link 108 or second communication link 106 and stored on the mobile device 102.

The mobile device 102 may also include a rendering module 122 configured to render the multimedia content items received over the content item communication link 108. The rendering module 122 may include one or more multimedia signal processing systems, such as video decoders, using decoding methods based on international standards such as MPEG-x and H.26x standards. Such decoding methods generally are directed towards decompressing the multimedia data received from the communication link 108 and memory.

The distribution system 110 may also include an insertion data service 130 that generates indicia, comprising data or metadata, indicative of an insertion point or time for displaying advertisement items within a stream of multimedia content and possibly an identification of associated content items. The insertion point or time may be expressed in a variety of format, such as an offset time within a content item, as an absolute time (i.e., time of day), as a frame number or identifier (i.e., using data indicative of a particular frame or portion of the content item), a data pattern to be found in, or calculated based on, the multimedia content (e.g. based on fingerprints calculated based on the audio or video track), etc. The identification of associated content items may be direct, e.g. a file name and location. For example, the identification may comprise a pointer (e.g., a Uniform Resource Locator (URL)) to a memory location of the content items to be displayed (representing a direct identification). The memory location may be a location within memory on the mobile device 102, the distribution system 110, the content provider 112, or on an entirely separate server (not illustrated). Alternatively, the identification may be indirect, indicating preferences as to the type or genre of content items to be selected. In the case of an indirect identification, another service may supply the direct identification. This other service may reside on the mobile device 102, the distribution system 110, the content provider 112, or on an entirely separate server (not illustrated). An indirect identification may comprise a pointer (e.g. a URL) to a server that dynamically provides content items. In this aspect, one or more parameters, such as a category, may be included with the indicia to provide information that may assist a user in making a selection of advertising content items. The indicia may be transmitted to the mobile device 102 via the first or second communication links 108, 106.

Advertisement content items may be stored in memory on the mobile device 102 in ad storage 134 and may be maintained or managed by an ad service application 132. The ad service application 132 may receive advertisement items, store the advertisement items in the ad storage 134, and provide access to the advertisement items for presentation proximate to insertion points identified by the insertion data service 130. The ad service 132 may also be responsible for identifying insertion points or time in the multimedia content stream based on indicia received from the insertion data service 130. At, or prior to, an insertion point within a multimedia content stream, the ad service 132 may determine whether, or which ones of, identified advertisement content items are stored in the ad storage 134 or are otherwise available. When the insertion point is reached and if the advertisement items are available, a user interface may be displayed to allow the user to select at least one of the advertisement items or types of advertising content for presentation to the user. The ad service 132 may be configured to generate this user interface display. Alternatively, instructions for generating the user interface display may be included in the advertisement content data stored in the ad storage 134. Also, metadata associated with the advertising content may specify how the user is to be prompted for a selection of an advertisement item, such as advertising category phrases, advertisement titles, user prompt phrases, and thumb nail images to be displayed as part of the user interface display.

The ad service 132 within the mobile device may receive advertisement content items (or other content items for presentation) from an ad data service 128 within the distribution system 110. The ad service 132 within the mobile device may be configured to select advertisement content items for inclusion in the user interface display based on advertiser preferences or broadcaster decisions, and broadcast such advertising content according to a predefined schedule. In another embodiment suitable communication systems which can narrow cast to one or a few mobile devices, the ad service 132 may be configured to select advertisement content items or types of advertising content for inclusion in the user interface display based on information about a user of the device, etc. For example, the ad service 132 may include, or communicate with, a user profile database (not illustrated) within memory of the mobile device to select advertisement items types of content for inclusion in the user interface display based on any number of parameters, including information about a user of the mobile device 102. For example, the content items may be selected based on user preferences, user demographic information, or other data associated with the user of the mobile device. Metadata associated with advertising content stored in the ad storage 134 portion of memory may identify the degree to which particular advertisement items are suitable for particular demographic parameters such as age ranges, gender, device usage patterns (e.g., whether the user is a heavy user of texting, email, or an Internet browser), etc. The ad data service 132 may then select advertisement items or types of advertising content to include in the user interface display based on demographic data of one or more users of the mobile device 102.

Table 1 illustrates an example of metadata that may be included with particular advertising content according to an embodiment.

TABLE 1

| Field | Example Value |
|---|---|
| Insertion Point | 10 seconds (offset) |
| Content_Item_1 | url1 |
| Content_Item_1_indicator | url1/1 |
| Content_Item_2 | url2 |
| Content_Item_2_indicator | url2/2 |
| Default_Content_Item | url3 |
| Prompt_data | url4 |

In the example data structure illustrated in table 1, an Insertion Point field may specify a time when or where advertisement items may be inserted in a multimedia content stream. Each record may include a plurality of Insertion Point fields and that any multimedia content may have one or more records associated therewith. A variety of fields are illustrated that may be used by the ad data service 132 to select a particular advertisement item for insertion in a multimedia content stream or for inclusion in the user interface display. The metadata may include one or more URLs or other memory address data identifying storage locations of advertising content. In the example embodiment illustrated in Table 1, advertising content items may be defined in the Content_{—}1 and Content_{—}2 fields. Corresponding indicator data may be defined in the Content_Item_{—}1_indicator and Content_Item_{—}2_indicator fields. The Prompt_data field may be used to define, or in this example point to a memory location where prompt data (e.g., text and/or graphics) may be stored for inclusion in the user interface display. The prompt data may include an identity, configuration, or other content associated with the prompt. In addition, or alternatively to a URL, the metadata may include a prompt text string directly within the metadata instead of specifying a memory URL.

As mentioned above, the ad service 132 may be configured to maintain the advertisement items in the ad storage 134. For example, the ad data service 128 of the distribution system 110 may broadcast a plurality of advertisement items (e.g., via the communication link 108), such as in between other broadcast content, in a subchannel, or via a particular transmission stream for which the ad service 132 provides content. When received by the mobile device 102 advertisement content items may be stored in the ad storage 134 until space is required for other advertising content items or until advertisement items expired. The advertisement items may expire (and be deleted from the ad storage 134) based on predefined policies, user preference settings, or expiration time data received with the advertisement items or included within the advertisement metadata. The ad storage 134 may include functionality to periodically delete advertisement items that have expired.

The contents of the ad storage 134 may be maintained based on information about a user of the mobile device, such as information stored in a user profile database. For example, storage space of the ad storage 134 may be managed so that advertisement items determined based on user profile data may be preferentially maintained in the ad storage 134.

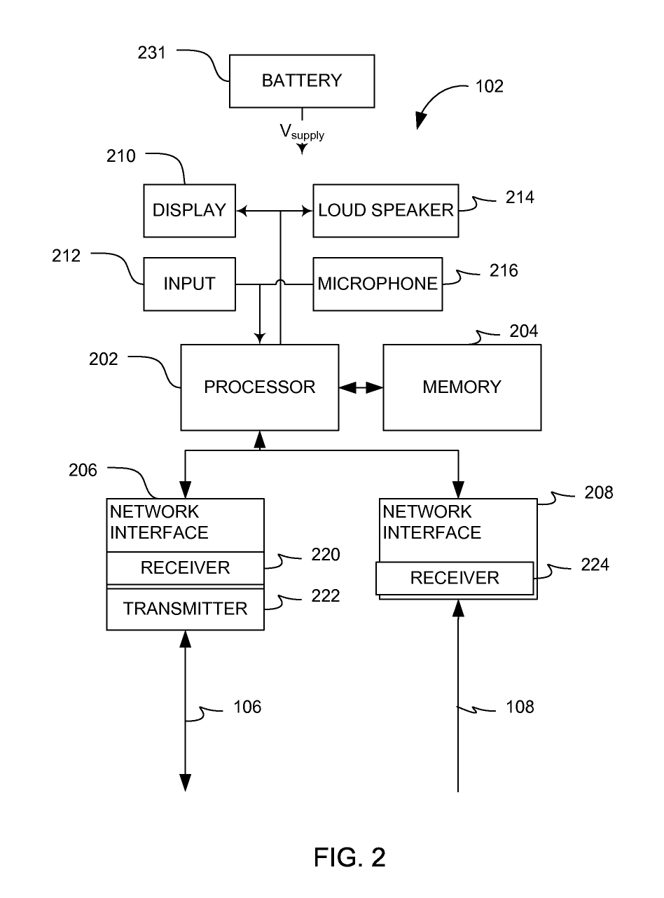

FIG. 2 is a block diagram of an example mobile device 102 of FIG. 1. The mobile device 102 includes a processor 202 that is in communication with a memory 204 and a network interface 208 that communicates over the communication link 108 via a receiver circuit 224. The network interface 208 and receiver circuit 224 may be coupled to an antenna (not shown) for receiving wireless communication signals. In the examples illustrated in FIG. 1 and FIG. 2, the communication link 108 is a forward link only communication link, in which case the network interface 208 includes a wireless receiver circuit 224 configured to receive and decode signals from the forward link only broadcaster, such as from a MediaFLO® system. However, as mentioned above, in some embodiments the network interface 208 and receiver 224 may be provisioned to receive signals according to other wired and wireless communication technologies. Examples of wired technologies for which the receiver circuit 224 may be configured include Ethernet, telephone (e.g., POTS), cable, power-line, and fiber optic systems. Examples of suitable wireless technologies include a code division multiple access (CDMA or CDMA2000) communication system, a frequency division multiple access (FDMA) system, a time division multiple access (TDMA) system such as GSM/GPRS (General Packet Radio Service)/EDGE (enhanced data GSM environment), a TETRA (Terrestrial Trunked Radio) mobile telephone system, a wideband code division multiple access (WCDMA) system, a high data rate (1xEV-DO or 1xEV-DO Gold Multicast) system, an IEEE 802.11 system, and an orthogonal frequency division multiple access (OFDM) system. Optionally, the first network interface 208 may also include processing capabilities (e.g., a modem processor) which may reduce processing requirements of the processor 202.

The mobile device 102 may include a second network interface 206 for communicating via the second communication link 106, which is illustrated as being a bi-directional communication link as shown in FIG. 1. The second network interface 206 may include an antenna (not shown), a receiver 220, and a transmitter 222 so that the mobile device 102 can communicate with one or more devices over the second communication link 106. Optionally, the second network interface 206 may also include processing capabilities (e.g., a modem processor) which may reduce processing requirements of the processor 202.

Typical mobile devices 102 suitable for use with the various embodiments will have in common the components illustrated in FIG. 2. For example, an exemplary mobile device 102 may include a processor 202 coupled to internal memory 204, a display 210, network interfaces 206 and 208, and a speaker 214. Mobile devices 102 typically also include a key pad or miniature keyboard and menu selection buttons or rocker switches for receiving user input 212 (e.g., in response to a user interface display) and a microphone 216 for receiving sound. The mobile device 102 may optionally include a battery 231 to provide power to one or more components of the device 102.

The processor 202 may be any programmable microprocessor, microcomputer or multiple processor chip or chips that can be configured by software instructions (applications) to perform a variety of functions, including the functions of the various embodiments described herein. In some mobile devices, multiple processors 202 may be provided, such as one processor dedicated to wireless communication functions and one processor dedicated to running other applications. Typically, software applications may be stored in the internal memory 204 before they are accessed and loaded into the processor 202. In some mobile devices, the processor 202 may include internal memory sufficient to store the application software instructions. In many mobile devices 102, the internal memory 204 may be a volatile or nonvolatile memory, such as flash memory, or a mixture of both. For the purposes of this description, a general reference to memory refers to all memory accessible by the processor 202, including internal memory 204, removable memory plugged into the mobile device 102, and memory within the processor 202 itself.

The mobile device 102 may be implemented using any suitable combination of the functions and components discussed above with reference to FIG. 2. For example, the mobile device 102 may comprise one or more integrated circuits and, in-turn, the integrated circuits may comprise one or more processors that provide the functionality of the processor 202 illustrated in FIG. 2. The integrated circuit may also comprise other types of components that implement some or all of the functionality of the illustrated processor components. Further, one or more processors may implement the functionality of the illustrated processor components.

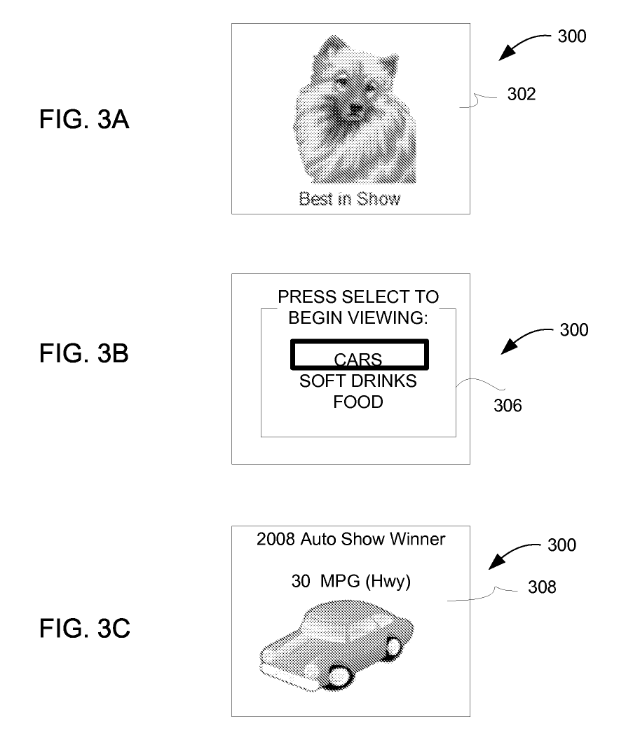

FIGS. 3A-3C illustrate images that may appear on the display of a mobile device in the process of presenting the user interface display and receiving a user input. In particular, FIGS. 3A-3C show a progression of screen shots illustrating an example user interface 300 presented on the display 210 of the mobile device 102.

FIG. 3A illustrates a display that may be presented when the mobile device is tuned into a first content item 302, namely a dog show. During the display of the first content stream of images, indicia of an insertion point in the content item may be received by the mobile device and recognized as indicating when a user interface display should be presented. Advertisement content items may also be received in the background during the reception of the first content item 302 and stored in the ad storage 134.

FIG. 3B illustrates a user interface display 306 that may be generated just prior to an advertisement insertion point. As illustrated, the user interface display may prompt a user of the mobile device to indicate by a user input which of listed advertisement items or types of advertising content the user would like to view. The user interface control 306 may comprise a prompt along with displayed graphical indicators of the advertisement items or types of advertising content, as well as other user interface elements, such as highlighting of a current selection, selection icons or selection button identifiers. For example, FIG. 3B shows a user interface display offering the user a choice among three types of advertisement content, namely automobile advertisements, soft drink advertisements, and food advertisements.

The graphical indicators used in generating the user interface display 306 may include text, pictures, drawings, animated or video content, sounds, any other suitable indicator, or combinations thereof. The graphical indicators, size, location, and other display attributes of the user interface control 306 may be predetermined, or may be specified by metadata associated with the advertising content or by the indicia of the insertion point. Parameters for displaying the user interface display 306 may be predefined, based on user preference settings, or identified by the metadata associated with the insertion point. For example, such metadata may specify the period of time that the user interface 306 is to be displayed (i.e., how long the user will be given to enter a selection before a default item is implemented).

In an embodiment, if no user input is received to select an advertisement item within the specified time period, the mobile device 102 may be configured to select a default advertisement item for presentation. The default advertisement item may be predefined or specified by the metadata associated with the indicia of the insertion point. In one aspect, the default advertisement item may be selected based on the respective durations of the advertisement items. For example, the default advertisement item may be one of the stored advertisement content items with the longest or shortest duration.

FIG. 3C illustrates the display of a car ad 308 following a user input selecting an automobile advertisement that was entered in response to the user interface 306. Upon completion of the ad presentation 308, the device 102 may automatically present other content items, either broadcast content items, or another content item based on further metadata indicative of the same or another insertion point.

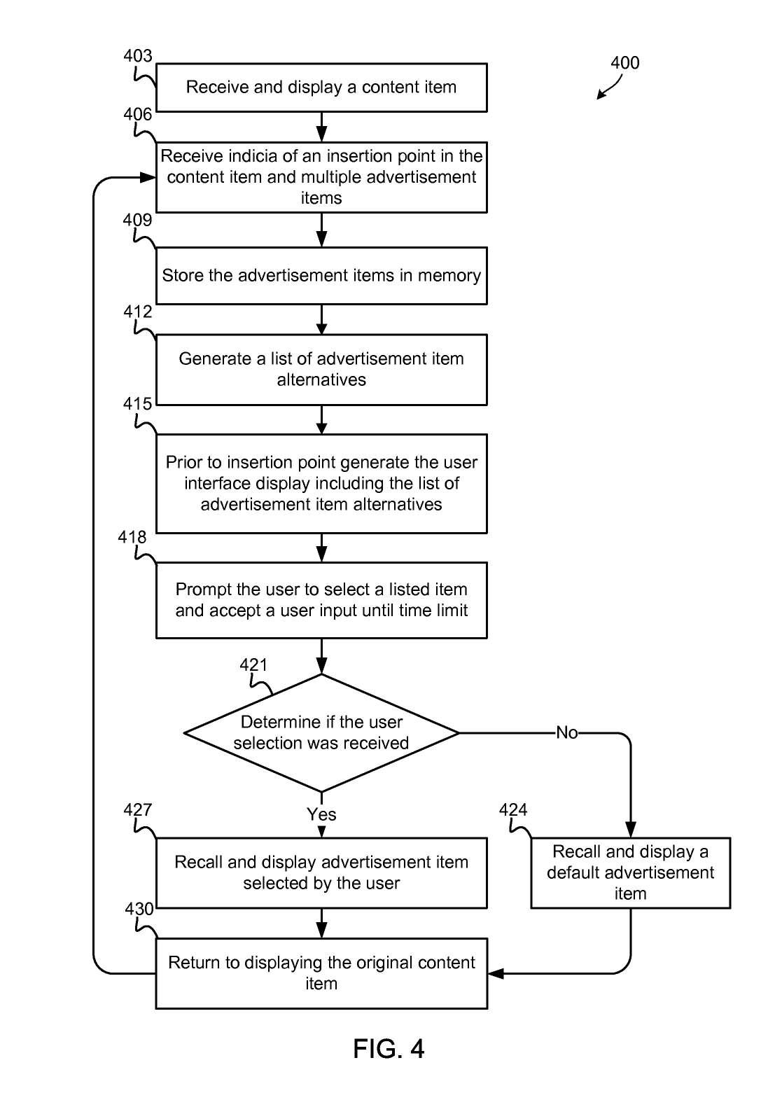

FIG. 4 illustrates an exemplary embodiment method 400 that may be implemented within a mobile device to display advertising content within a multimedia content stream based upon user selections entered in response to a user interface display. In method 400 at step 403 the mobile device receives a multimedia content stream from a broadcast system. During reception and display of the content stream, the mobile device may receive an indicia of an insertion point, step 406. Before or during reception of the content stream the mobile device may also receive multiple advertisement content items, step 406. As advertisement items are received they may be stored in memory on the mobile device, step 409. At a time prior to the insertion point (e.g., at a time specified in the indicia received in step 406), the mobile device may generate a list of alternative advertisement items or types of advertising content, step 412. This list of alternatives may comprise the content in the user interface display and may be determined based upon advertisement items currently stored on the mobile device, items previously identified, metadata or data sent with the indicia of the insertion point, user demographic data, and combinations of these factors, as well as others.

In step 415, at a time prior to the insertion point (i.e., before the time specified in the insertion point indicia when an advertisement item should begin) the mobile device may generate a user interface display based upon the determined list of advertisement item alternatives. This user interface display may include any of the graphical indicators discussed above with reference to FIG. 3B. The input may include a user prompt for an input, such as text asking the user to press an icon or button to indicate a selected alternative, and the mobile device may stand by to accept the user input for the duration of a time limit in step 418. This time limit may be predefined in the mobile device, such as in the form of a factory or user preference setting, or specified by metadata in the advertising content items or the insertion point indicia as may be defined by the distribution system, the content provider, the advertiser, or other service, and may vary each time the user is prompted.

Upon receipt of a user input or at the end of the time limit the mobile device may determine whether a user selection input was received, determination step 421. If the mobile device determines that a user selection was received (i.e., determination step 421=“Yes”), the mobile device may recall from memory the selected advertisement item or an advertisement item matching the advertisement type selected by the user and begin to display the content, step 427. If the mobile device determines that a user selection was not received (i.e., determination step 421=“No”), the mobile device may recall and begin to display a default advertisement item, step 424. The default advertisement item may be a content item stored in memory. In an alternative embodiment, the default advertisement may be an ad within the broadcast content stream, in which case step 424 may require no further action by the mobile device. After the selected or default advertisement item has been displayed, the mobile device may return to displaying the multimedia content stream, step 430.

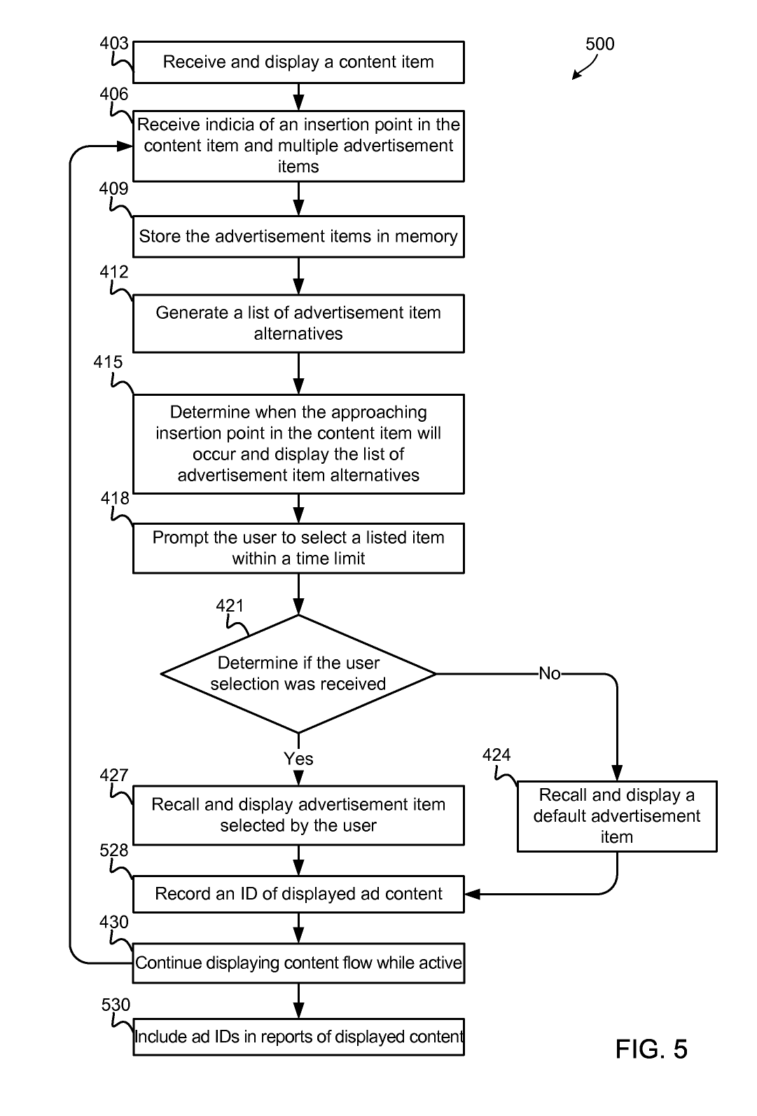

FIG. 5 illustrates a second exemplary embodiment method 500 that may be implemented within a mobile device to display advertising content within a multimedia content stream based upon user selections with results of user selections reported to the broadcaster or another party. Such reporting of advertisements actually viewed may be economically valuable since broadcasters or content providers can charge advertisers based upon ads actually viewed rather than projections based upon the content viewed.

The embodiment method 500 illustrated in FIG. 5 includes the same steps as embodiment method 400 described above with reference to FIG. 4, plus additional steps 528 and 530 associated with the recording and reporting of advertisements viewed. After a particular advertisement is selected for display based upon a user selection or lack of a selection (i.e., selection of a default ad), the mobile device may record an identifier (ID) of the advertisement that was displayed. Such an advertisement ID may be any type of identifier that the broadcaster or content provider can correlate to the particular advertisement. The advertisement ID may be stored in memory in a format and manner similar to how the mobile device may keep track of the content viewed by the user. For example, in the MediaFLO® broadcast system, mobile devices keep track of the IDs of content flows selected for viewing and periodically report this information to the broadcaster (e.g., via the second communication link 106 discussed above with reference to FIG. 1). Thus, a viewer reporting mechanism already exists in MediaFLO® that may be used for tracking and reporting the advertisements selected and viewed by users simply by configuring mobile devices to record the ID of viewed advertisements. Then, as part of the periodic reporting of user viewing selections the mobile device can report the IDs of advertisements actually displayed, step 530. This periodic reporting may be made at any time, such as after or during display of a content stream.

The reporting of advertisements viewed enabled by method 500 may be used by the broadcaster, content provider or advertisers to establish a user profile to assist in the selection of advertisements that are broadcast to mobile devices and received in step 406. Reporting of such data may also help distributors and content providers measure the market response to advertisement items based upon the number of times each particular ad was actually viewed correlated to consumer purchases. Data on advertisements viewed may also be useful to content providers and advertisers, allowing content providers to charge more for ads that were selected by users (thus indicating some user preference for the product), and enabling advertisers to pay only for those that were actually viewed.

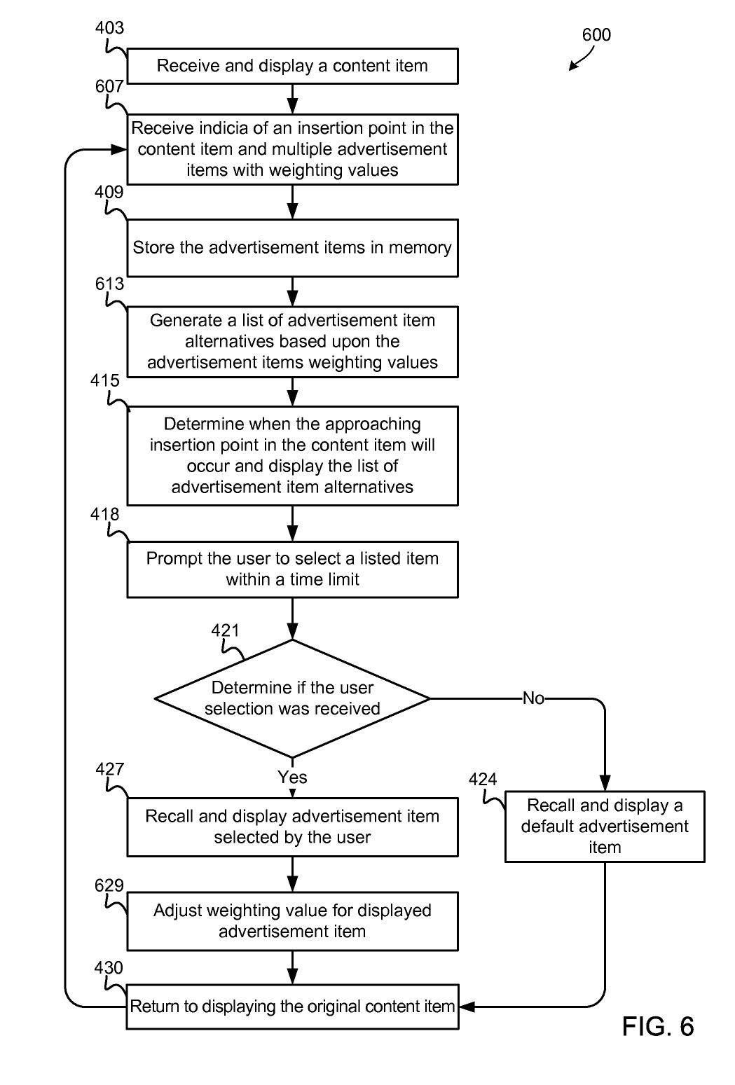

FIG. 6 illustrates another exemplary embodiment method 600 that may be implemented within a mobile device to display advertising content within a multimedia content stream based upon user selections and weighting factors based upon prior user selections and user preferences. Method 600 is also similar to method 400, with changes to include selecting advertisements based on weighting values that are adjusted based on user inputs. In method 600 at step 403 the mobile device receives a multimedia content stream from a broadcast system. In step 607, the mobile device may receive indicia of an insertion point, as well as advertisement content items which include assigned weighting values. These advertisement weighting values may be assigned by the broadcaster, the content provider, advertisers, or others parties. The advertisement weighting values may be transmitted as metadata or data associated with each advertisement content item, or as a separate data structure transmitted in a separate data stream. The weighting factors associated with advertisement content may be used by mobile devices to select items for inclusion in each user interface display (including how frequently the ad is included in user interface displays) and/or for determining the order of items listed in the user interface display. Weighting factors may also be used by mobile devices to select a default advertisement, including determining how frequently a particular ad appears as the default advertisement. Weighting values may be assigned based on many factors, such as the price paid by the advertiser, correlation to the mobile device's user profile, success or popularity of the advertisement item, etc. For example, content providers may charge advertisers based upon assigned weighting factors, and advertisers can choose to pay for weighting factors that will result in their desired frequency of presentation to users.

In step 409 advertisement items received in step 607 may be stored in memory. In step 613 the mobile device may generate a list of advertisement item alternatives to be included in the next user interface display based upon the advertisement weighting factors. Advertisement weighting factors may be used to generate this list using a variety of algorithms. For example, in a list of three alternative advertisements, the one with the highest weighting factor may be listed first. As another example, those ads with the three highest weighting factors may be selected for a first user interface display, with the next three highest ads selected for the next user interface display, and so forth. In another example, the weighting factors may be used in combination with an algorithm that selects ads for the menu based upon when each ad last appeared in the menu and when each ad last was selected for display. In this manner, advertisement content with higher weighting factors may be selected for inclusion in the user interface display more frequently than those with lower weighting factors.

In step 415, at a time prior to the insertion point the mobile device may generate a user interface display based upon the determined list of advertisement item alternatives and await the user's input in step 418 as described above with reference to FIG. 4. The mobile device may determine whether a user selection was received in determination step 421. If the mobile device determines that a user selection was received (i.e., determination step 421=“Yes”), the mobile device may recall from memory the selected advertisement item or an advertisement item matching the advertisement type selected by the user and begin to display it, step 427. If the mobile device determines that a user selection was not received (i.e., determination step 421=“No”), the mobile device may recall and begin to display a default advertisement item, step 424. In step 629, the mobile device may adjust the weighting value of the selected or default advertisement item to be displayed. This optional adjustment to the weighting value of the selected advertisement item may be accomplished in a manner that will prevent the item from being repeatedly selected for the list of advertisement item alternatives in step 613, thus keeping the list of alternatives fresh. Alternatively, the weighting factor may be enhanced to reflect the user's selection, so that over time the user's favorite advertisements are preferentially presented for selection. After the selected or default advertisement item has been displayed, the mobile device may return to displaying the original content item, step 430. Additionally, as part of this embodiment, the mobile device may track the ads viewed and periodically report this information as described above with reference to FIG. 5.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments. If implemented in software, the functions may be stored on or transmitted over as one or more instructions or code on a tangible computer-readable or processor-readable storage medium. The steps of a method or algorithm disclosed herein may be embodied in a processor-executable software module executed which may reside on a computer-readable storage medium. A computer-readable or processor-readable storage medium may be any available tangible storage media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A method for selecting advertisement content for display on a mobile device based on user interaction, comprising:
receiving a multimedia content stream in the mobile device;
receiving an indication of an insertion point for an advertisement within the multimedia content stream;
displaying a prompt for a user of the mobile device to input a selection related to advertisement content during display of the multimedia content item on the mobile device;
determining an advertising content item for display based upon a received user input if any; and
displaying the determined advertisement content item on the mobile device beginning at the insertion point.

2. The method of claim 1, further comprising:
receiving advertising content items prior to receiving the indication of an insertion point; and
storing the received advertising content in memory of the mobile device,
wherein displaying the determined advertisement content item on the mobile device beginning at the insertion point comprises recalling the determined advertisement content item from memory.

3. The method of claim 2, further comprising:
recording an identifier of the determined advertisement content item; and
reporting the identifier of the advertisement content item to a service.

4. The method of claim 2, further comprising:
accepting a user input following display of the prompt for a user input until a time limit expires; and
determining whether a user a user input was received within the time limit,
wherein determining an advertising content item for display based upon a received user input if any comprises selecting a default advertisement content item when it is determined that a user input was not received within the time limit.

5. The method of claim 4, wherein displaying a prompt for a user of the mobile device to input a selection related to advertisement content comprises generating a user interface display including a list of alternative selections related to advertising content and providing user input interfaces configured to enable a user to indicate a selected alternative by activating one of the provided user input interfaces.

6. The method of claim 5, wherein:
the list of alternative selections related to advertising content comprises a list of alternative advertisement content items; and
determining an advertising content item for display based upon a received user input if any comprises selecting an advertisement content item corresponding to a received user input when it is determined that a user input was received within the time limit.

7. The method of claim 5, wherein:
the list of alternative selections related to advertising content comprises a list of types of advertisement content; and
determining an advertising content item for display based upon a received user input if any comprises selecting an advertisement content item of a type matching a type of advertisement content corresponding to a received user input when it is determined that a user input was received within the time limit.

8. The method of claim 5, wherein generating a user interface display including a list of alternative selections related to advertising content comprises generating a list of alternative selections related to advertising content based upon user preference settings.

9. The method of claim 5, wherein generating a user interface display including a list of alternative selections related to advertising content comprises generating a list of alternative selections related to advertising content based upon user demographic information.

10. The method of claim 5, wherein:
received advertising content items include a corresponding weighting value; and
generating a user interface display including a list of alternative selections related to advertising content comprises generating the list of alternative advertisement content items based on the corresponding weighting values of advertisement content items stored in memory.

11. The method of claim 10, further comprising:
adjusting the weighting value corresponding to the displayed advertisement content item.

12. The method of claim 10, wherein:
the received indication of an insertion point for an advertisement within the multimedia content stream includes metadata related to selecting advertisement content items for inclusion in the list of alternative selections; and
generating the list of alternative advertisement content items based on the corresponding weighting values of advertisement content items stored in memory further comprises generating the list of alternative advertisement content items based on the corresponding weighting values and the metadata included in the received indication of an insertion point.

13. A mobile device configured to display advertisement content based on user interaction, comprising:
means for receiving a multimedia content stream;
means for receiving an indication of an insertion point for an advertisement within the multimedia content stream;
means for displaying a prompt for a user of the mobile device to input a selection related to advertisement content during display of the multimedia content item on the mobile device;
means for determining an advertising content item for display based upon a received user input if any; and
means for displaying the determined advertisement content item beginning at the insertion point.

14. The mobile device of claim 13, further comprising:
means for receiving advertising content items prior to receiving the indication of an insertion point; and
memory means for storing the received advertising content,
wherein means for displaying the determined advertisement content item beginning at the insertion point comprises means for recalling the determined advertisement content item from the memory means.

15. The mobile device of claim 14, further comprising:
means for recording an identifier of the determined advertisement content item; and
means for reporting the identifier of the advertisement content item to a service.

16. The mobile device of claim 14, further comprising:
means for accepting a user input following display of the prompt for a user input until a time limit expires; and
means for determining whether a user a user input was received within the time limit,
wherein means for determining an advertising content item for display based upon a received user input if any comprises means for selecting a default advertisement content item when it is determined that a user input was not received within the time limit.

17. The mobile device of claim 16, wherein means for displaying a prompt for a user of the mobile device to input a selection related to advertisement content comprises means for generating a user interface display including a list of alternative selections related to advertising content and providing user input interfaces configured to enable a user to indicate a selected alternative by activating one of the provided user input interfaces.

18. The mobile device of claim 17, wherein:
the list of alternative selections related to advertising content comprises a list of alternative advertisement content items; and
means for determining an advertising content item for display based upon a received user input if any comprises means for selecting an advertisement content item corresponding to a received user input when it is determined that a user input was received within the time limit.

19. The mobile device of claim 17, wherein:
the list of alternative selections related to advertising content comprises a list of types of advertisement content; and
means for determining an advertising content item for display based upon a received user input if any comprises means for selecting an advertisement content item of a type matching a type of advertisement content corresponding to a received user input when it is determined that a user input was received within the time limit.

20. The mobile device of claim 17, wherein means for generating a user interface display including a list of alternative selections related to advertising content comprises means for generating a list of alternative selections related to advertising content based upon user preference settings.

21. The mobile device of claim 17, wherein means for generating a user interface display including a list of alternative selections related to advertising content comprises means for generating a list of alternative selections related to advertising content based upon user demographic information.

22. The mobile device of claim 17, wherein:
received advertising content items include a corresponding weighting value; and
means for generating a user interface display including a list of alternative selections related to advertising content comprises means for generating the list of alternative advertisement content items based on the corresponding weighting values of advertisement content items stored in the memory means.

23. The mobile device of claim 22, further comprising:
means for adjusting the weighting value corresponding to the displayed advertisement content item.

24. The mobile device of claim 22, wherein:
the received indication of an insertion point for an advertisement within the multimedia content stream includes metadata related to selecting advertisement content items for inclusion in the list of alternative selections; and
means for generating the list of alternative advertisement content items based on the corresponding weighting values of advertisement content items stored in memory further comprises means for generating the list of alternative advertisement content items based on the corresponding weighting values and the metadata included in the received indication of an insertion point.

25. A mobile device configured to display advertisement content based on user interaction, comprising:
a processor;
a display coupled to the processor;
a receiver circuit coupled to the processor and configured to receive multimedia broadcasts; and
a memory coupled to the processor,
wherein the processor is configured with processor-executable instructions to perform operations comprising:
receiving a multimedia content stream from the receiver circuit;
receiving an indication of an insertion point for an advertisement within the multimedia content stream;
displaying a prompt for a user of the mobile device to input a selection related to advertisement content during display of the multimedia content item on the display;
determining an advertising content item for display based upon a received user input if any; and
displaying the determined advertisement content item on the display beginning at the insertion point.

26. The mobile device of claim 25, wherein the processor is configured with processor-executable instructions to perform operations further comprising:
receiving advertising content items prior to receiving the indication of an insertion point; and
storing the received advertising content in the memory,
wherein displaying the determined advertisement content item on the display beginning at the insertion point comprises recalling the determined advertisement content item from the memory.

27. The mobile device of claim 26, wherein the processor is configured with processor-executable instructions to perform operations further comprising:
recording an identifier of the determined advertisement content item; and
reporting the identifier of the advertisement content item to a service.

28. The mobile device of claim 26, wherein the processor is configured with processor-executable instructions to perform operations further comprising:
accepting a user input following display of the prompt for a user input until a time limit expires; and
determining whether a user a user input was received within the time limit,
wherein determining an advertising content item for display based upon a received user input if any comprises selecting a default advertisement content item when it is determined that a user input was not received within the time limit.

29. The mobile device of claim 28, wherein the processor is configured with processor-executable instructions to perform operations such that displaying a prompt for a user of the mobile device to input a selection related to advertisement content comprises generating a user interface display including a list of alternative selections related to advertising content and providing user input interfaces configured to enable a user to indicate a selected alternative by activating one of the provided user input interfaces.

30. The mobile device of claim 29, wherein the processor is configured with processor-executable instructions to perform operations such that:
the list of alternative selections related to advertising content comprises a list of alternative advertisement content items; and
determining an advertising content item for display based upon a received user input if any comprises selecting an advertisement content item corresponding to a received user input when it is determined that a user input was received within the time limit.

31. The mobile device of claim 29, wherein the processor is configured with processor-executable instructions to perform operations such that:
the list of alternative selections related to advertising content comprises a list of types of advertisement content; and
determining an advertising content item for display based upon a received user input if any comprises selecting an advertisement content item of a type matching a type of advertisement content corresponding to a received user input when it is determined that a user input was received within the time limit.

32. The mobile device of claim 29, wherein the processor is configured with processor-executable instructions to perform operations such that generating a user interface display including a list of alternative selections related to advertising content comprises generating a list of alternative selections related to advertising content based upon user preference settings.

33. The mobile device of claim 29, wherein the processor is configured with processor-executable instructions to perform operations such that generating a user interface display including a list of alternative selections related to advertising content comprises generating a list of alternative selections related to advertising content based upon user demographic information.

34. The mobile device of claim 29, wherein the processor is configured with processor-executable instructions to perform operations such that:
received advertising content items include a corresponding weighting value; and
generating a user interface display including a list of alternative selections related to advertising content comprises generating the list of alternative advertisement content items based on the corresponding weighting values of advertisement content items stored in memory.

35. The mobile device of claim 34, wherein the processor is configured with processor-executable instructions to perform operations further comprising:
adjusting the weighting value corresponding to the displayed advertisement content item.

36. The mobile device of claim 34, wherein the processor is configured with processor-executable instructions to perform operations such that:
the received indication of an insertion point for an advertisement within the multimedia content stream includes metadata related to selecting advertisement content items for inclusion in the list of alternative selections; and
generating the list of alternative advertisement content items based on the corresponding weighting values of advertisement content items stored in memory further comprises generating the list of alternative advertisement content items based on the corresponding weighting values and the metadata included in the received indication of an insertion point.

37. A tangible processor-readable storage medium having stored thereon processor-executable instructions configured to cause a processor of a mobile device to perform operations comprising:
receiving a multimedia content stream;
receiving an indication of an insertion point for an advertisement within the multimedia content stream;
displaying a prompt for a user of the mobile device to input a selection related to advertisement content during display of the multimedia content item on the mobile device;
determining an advertising content item for display based upon a received user input if any; and
displaying the determined advertisement content item on the mobile device beginning at the insertion point.

38. The tangible processor-readable storage medium of claim 37, wherein the stored processor-executable instructions are configured to cause a processor of a mobile device to perform operations further comprising:
receiving advertising content items prior to receiving the indication of an insertion point; and
storing the received advertising content in memory of the mobile device,
wherein displaying the determined advertisement content item on the mobile device beginning at the insertion point comprises recalling the determined advertisement content item from memory.

39. The tangible processor-readable storage medium of claim 38, wherein the stored processor-executable instructions are configured to cause a processor of a mobile device to perform operations further comprising:
recording an identifier of the determined advertisement content item; and
reporting the identifier of the advertisement content item to a service.

40. The tangible processor-readable storage medium of claim 38, wherein the stored processor-executable instructions are configured to cause a processor of a mobile device to perform operations further comprising:
accepting a user input following display of the prompt for a user input until a time limit expires; and
determining whether a user a user input was received within the time limit,
wherein determining an advertising content item for display based upon a received user input if any comprises selecting a default advertisement content item when it is determined that a user input was not received within the time limit.

41. The tangible processor-readable storage medium of claim 40, wherein the stored processor-executable instructions are configured to cause a processor of a mobile device to perform operations such that displaying a prompt for a user of the mobile device to input a selection related to advertisement content comprises generating a user interface display including a list of alternative selections related to advertising content and providing user input interfaces configured to enable a user to indicate a selected alternative by activating one of the provided user input interfaces.

42. The tangible processor-readable storage medium of claim 41, wherein the stored processor-executable instructions are configured to cause a processor of a mobile device to perform operations such that:
the list of alternative selections related to advertising content comprises a list of alternative advertisement content items; and
determining an advertising content item for display based upon a received user input if any comprises selecting an advertisement content item corresponding to a received user input when it is determined that a user input was received within the time limit.

43. The tangible processor-readable storage medium of claim 41, wherein the stored processor-executable instructions are configured to cause a processor of a mobile device to perform operations such that:
the list of alternative selections related to advertising content comprises a list of types of advertisement content; and
determining an advertising content item for display based upon a received user input if any comprises selecting an advertisement content item of a type matching a type of advertisement content corresponding to a received user input when it is determined that a user input was received within the time limit.

44. The tangible processor-readable storage medium of claim 41, wherein the stored processor-executable instructions are configured to cause a processor of a mobile device to perform operations such that generating a user interface display including a list of alternative selections related to advertising content comprises generating a list of alternative selections related to advertising content based upon user preference settings.

45. The tangible processor-readable storage medium of claim 41, wherein the stored processor-executable instructions are configured to cause a processor of a mobile device to perform operations such that generating a user interface display including a list of alternative selections related to advertising content comprises generating a list of alternative selections related to advertising content based upon user demographic information.

46. The tangible processor-readable storage medium of claim 41, wherein the stored processor-executable instructions are configured to cause a processor of a mobile device to perform operations such that:
received advertising content items include a corresponding weighting value; and
generating a user interface display including a list of alternative selections related to advertising content comprises generating the list of alternative advertisement content items based on the corresponding weighting values of advertisement content items stored in memory.

47. The tangible processor-readable storage medium of claim 46, wherein the stored processor-executable instructions are configured to cause a processor of a mobile device to perform operations further comprising:
adjusting the weighting value corresponding to the displayed advertisement content item.

48. The tangible processor-readable storage medium of claim 46, wherein the stored processor-executable instructions are configured to cause a processor of a mobile device to perform operations such that:
the received indication of an insertion point for an advertisement within the multimedia content stream includes metadata related to selecting advertisement content items for inclusion in the list of alternative selections; and
generating the list of alternative advertisement content items based on the corresponding weighting values of advertisement content items stored in memory further comprises generating the list of alternative advertisement content items based on the corresponding weighting values and the metadata included in the received indication of an insertion point.

49. A wireless communication system, comprising:
a multimedia broadcast network, comprising:
means for broadcasting a multimedia content stream;
means for including an indication of an insertion point for an advertisement within the multimedia content stream; and
means for broadcasting a plurality of advertisements in advance of the insertion point for an advertisement; and
a mobile device configured to display advertisement content based on user interaction, comprising:
means for receiving the broadcasted plurality of advertisements;
means for storing the received broadcasted plurality of advertisements;
means for receiving the multimedia content stream;
means for receiving the indication of an insertion point for an advertisement within the multimedia content stream;
means for displaying a prompt for a user of the mobile device to input a selection related to advertisement content during display of the multimedia content item;
means for receiving a user input in response to the displayed prompt;
means for determining an advertising content item from among the stored plurality of advertisements for display based upon a received user input if any; and
means for displaying the determined advertisement content item beginning at the insertion point.

50. A wireless communication system, comprising:
a multimedia broadcast network, comprising:
a server; and
a broadcast transmitter system coupled to the server,
wherein the server is configured with server-executable instructions to format content for broadcast and to direct the broadcast transmitter system to:
broadcast a multimedia content stream;
include an indication of an insertion point for an advertisement within the multimedia content stream; and
broadcast a plurality of advertisements in advance of the insertion point for an advertisement; and
a mobile device configured to display advertisement content based on user interaction, comprising:
a processor;
a display coupled to the processor;
a receiver circuit coupled to the processor and configured to receive multimedia broadcasts; and
a memory coupled to the processor,
wherein the processor is configured with processor-executable instructions to perform operations comprising:
receiving the broadcasted plurality of advertisements via the receiver circuit;
storing the received broadcasted plurality of advertisements in the memory;
receiving the multimedia content stream via the receiver circuit;
receiving the indication of an insertion point for an advertisement within the multimedia content stream;
displaying a prompt for a user of the mobile device to input a selection related to advertisement content during display of the multimedia content item on the display;
receiving a user input in response to the displayed prompt;
determining an advertising content item from among the stored plurality of advertisements for display based upon a received user input if any;
recalling the determined advertisement content from the memory; and
displaying the determined advertisement content item on the display beginning at the insertion point.
